(19) United States
(12) Patent Application Publication
(10) Pub. No.: US 2006/0200376 A1
(43) Pub. Date: Sep. 7, 2006

(54) Method of and apparatus for generating a demand forecast

(75) Inventors: Weitao Wang, South Windsor, CT (US); Thomas W. Gannon, East Hampton, CT (US); Kevin J. Kirkpatrick, Avon, IN (US); Rumen Efremov, Glastonbury, CT (US); Matthew J. McGarry, Simsbury, CT (US)

Correspondence Address: PRATT & WHITNEY, 400 MAIN STREET, MAIL STOP: 132-13, EAST HARTFORD, CT, 06108, US

(73) Assignee: United Technologies Corporation

(21) Appl. No.: 11/074,175

(22) Filed: Mar. 7, 2005

(51) Int. Cl. G07G 1/00

(52) U.S. Cl. 705/10

(57) ABSTRACT

A method of forecasting demand comprises the steps of providing a database containing information regarding a plurality of parts, accessing the database to create a first demand forecast for at least one of the plurality of parts, identifying a group from the plurality of parts, and accessing the database to create a second demand forecast for the group.

### BACKGROUND OF THE INVENTION

1. Field of the Invention

The present invention relates generally to a method of and apparatus for generating a demand forecast. More particularly, the present invention relates to a method of and apparatus for utilizing information regarding a plurality of parts to generate a short-term and a long-term demand forecast.

2. Description of the Background of the Invention

Repair facilities gather and monitor repair demand data for their individual location. For example, an engine center will keep track of all the routine maintenance and general repairs that it conducts on each engine. Such information may include details regarding who owns the engine and the type of engine, and may further include information about the specific work that was done on the engine. This could include such details as whether a particular part or set of parts were repaired or replaced within the engine.

By analyzing these data, each engine center may be able to create an average of how many and what kinds of repairs are done on a regular basis. With this information, the engine centers can estimate repair demand and determine what tools and materials will need to be on hand and how much labor will be required. This estimated future capacity will enable the engine center to run more efficiently and keep its inventory costs low.

Currently, each individual engine center generates its own forecast based on its experience with individual customers. The engine centers typically do not share information with other facilities, even facilities owned by the same company. As a result, the engine centers have limited, if any, exposure to the entire repair demand stream. This results in a piecemeal process for analyzing demand. This piecemeal approach results in duplicated efforts at each individual engine center. In addition, there is no centralized repair demand data that may be used to provide a company-wide repair demand forecast. A company-wide forecast would more accurately provide information regarding the entire company's necessary capacity. This information may be useful, not only to the company itself, but also to organizations from which the company orders supplies (e.g., spare parts), materials, and services (e.g., repair of existing parts).

### SUMMARY OF THE INVENTION

One aspect of the present invention comprises a method of forecasting demand that includes the steps of providing a database containing information regarding a plurality of parts and accessing the database to create a first demand forecast for at least one of the plurality of parts. The method further includes the steps of identifying a group from the plurality of parts and accessing the database to create a second demand forecast for the group.

A further aspect of the present invention comprises a computer assisted system for forecasting demand including means for providing a database containing information regarding a plurality of parts and means for accessing the database to create a first demand forecast for at least one of the plurality of parts. The system further includes means for identifying a group from the plurality of parts having similar characteristics and means for accessing the database to create a second demand forecast for the group.

And yet a further aspect of the present invention comprises a method of forecasting demand that includes the steps of providing a database containing information regarding a plurality of parts, where at least two of the parts having a common attribute, and accessing the database to create a first demand forecast for at least one of the plurality of parts. The method further includes the step of accessing the database to create a second demand forecast for the parts having the common attribute.

A final aspect of the present invention comprises a method of forecasting demand that includes the steps of providing a database containing information regarding a plurality of parts and accessing the database to create a first demand forecast at a part number level. The method further includes the step of accessing the database to create a second demand forecast at a part family level.

### BRIEF DESCRIPTION OF THE DRAWINGS

FIG. 1 is a flow chart illustrating one embodiment of a method of generating a demand forecast, in accordance with the present invention.

FIG. 2 is a flow chart illustrating a process for cleansing the data in accordance with the method of FIG. 1.

### DETAILED DESCRIPTION OF THE PREFERRED EMBODIMENTS

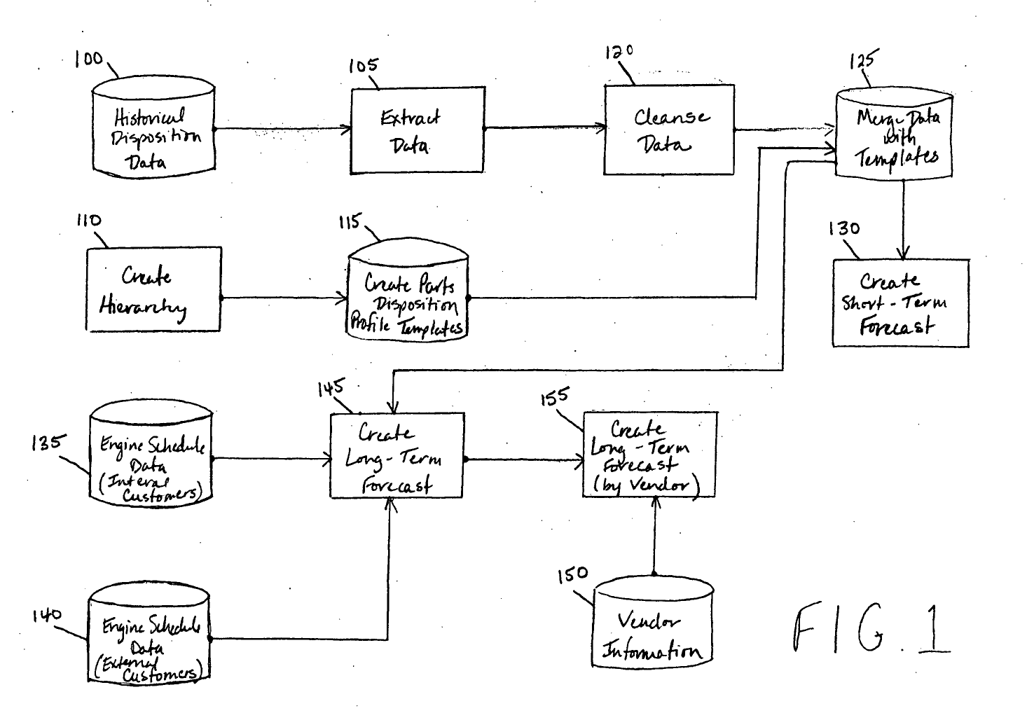

Referring to FIG. 1, one embodiment of a method of generating a demand forecast is shown. A database 100 contains information representing specific transactions involving products at a facility, such as gas turbine engines serviced by an engine overhaul center. The information from such transactions could detail the specific part or parts that were serviced on the engine and the disposition of those parts. Typical dispositions include “scrapped at vendor,” “scrapped at engine center,” “repaired at vendor,” “repaired at engine center,” and “deemed serviceable” (i.e., will be reused for reassembly without the need for any repairs).

Block 105 extracts transactional data from database 100 in which the engines have already been serviced and shipped back to the customer. Data that are extracted for each transaction include, but are not necessarily limited to, the sales order number, the customer number, the engine serial number, the workscope of the engine (described below), the number of engine hours, the transaction date, the part number that was worked on or replaced within the engine, the units per engine of the part, the engine center that worked on the engine, and the vendor associated with the part. A typical extracted record might resemble the following:

| | | | | | | | Units per | | |
|---|---|---|---|---|---|---|---|---|---|
| Order # | Cust # | Eng Ser # | Workscope | Hrs | Date | Part # | Engine (UPE) | Eng Ctr | Vendor |
| 000123 | Cust1 | 4567A | Medium | 32 | 2.4.2004 | 53D925 | 12 | Chicago | Vend1 |

At any point, and for purposes to be illustrated later, block 110 groups engine and part information in a hierarchical manner. At the broadest level, the data may be grouped by engine center, for example Chicago or Hartford. Below that, data may be grouped by which customer owns the engine. For example, Chicago may have two customers, called simply Cust1 and Cust2. The engine models that are serviced for each customer may then be grouped into engine families. Each engine family is an aggregation of engine models having similar configurations. Pratt & Whitney, for example, has developed one such engine family, PW4000 engines, which are a group of large-scale aircraft engines having similar configurations.

Each engine family may also have various workscopes associated with it. A workscope describes the level of services that the engine center will perform on the engine family. A workscope may be a heavy, medium, or light overhaul, depending on a predetermined level of work required to service the engine. For example, a heavy overhaul involves the disassembly of the engine modules (e.g. high pressure turbine, low pressure compressor) down to the parts level.

For example, Cust1 from Chicago's engine center may have several engine families associated with it, such as the PW4000 and GP7000. Cust2 may also have several engine families associated with it, for example the GP7000 and V2500. And since each engine family within each customer grouping will also have a workscope associated with it, Cust1 may have engine family PW4000 (heavy workscope), engine family PW4000 (medium workscope), and engine family PW4000 (light workscope).

Within each engine family, aggregated parts within the engine may be grouped into part families. This grouping is beneficial because part families, by definition, are parts that are interchangeable at a specific location within the engine (e.g., as identified by Air Transport Association Specification 100, such as 72-33-03 and 72-33-04) and require similar repair processes. As a result of this aggregation, PW4000 (medium workscope), belonging to Cust1, may have several part families associated with it. At the lowest level, just below the part family level, parts may be identified by their specific part number. For example, the part family at location 72-33-03 may include part number 53D925.

Block 115 uses the hierarchical grouping created by block 110 to create templates for each part family. Templates can be created at different levels of the hierarchy to create different profiles, and as a result, different forecasts. For example, a forecast could be created for the entire company, for each engine center, or for each customer serviced by a particular engine center.

Using the example discussed above, and creating a forecast to be used by the entire company, a template will be created for part family 72-33-03 of engine family PW4000 (having a medium workscope). The template will include all of the possible dispositions of a part belonging to this part family, including “scrapped at vendor” (SV), “scrapped at engine center” (SE), “repaired at vendor” (RV), “repaired at engine center” (RE), and “deemed serviceable” (S) for that part family. It will also include a field for storing the total number of disposition records from database 100 in which the engine being serviced belongs to engine family PW4000. The template will further include an “exposure” field for storing the number of times work was done on a part belonging to part family 72-33-03 when engine family PW4000 was serviced. These two additional fields allow a percentage to be created representing the chance that work will be done on part family 72-33-03 when engine family PW4000 is brought into the engine center. For example, the profile template created for part family 72-33-03 might appear as follows:

| | Work- | | | | | | | | |
|---|---|---|---|---|---|---|---|---|---|
| Eng. Fam. | scope | Part Fam. | SV | SE | RV | RE | S | Exp. | Total |
| PW4000 | Medium | 72-33-03 | | | | | | | |

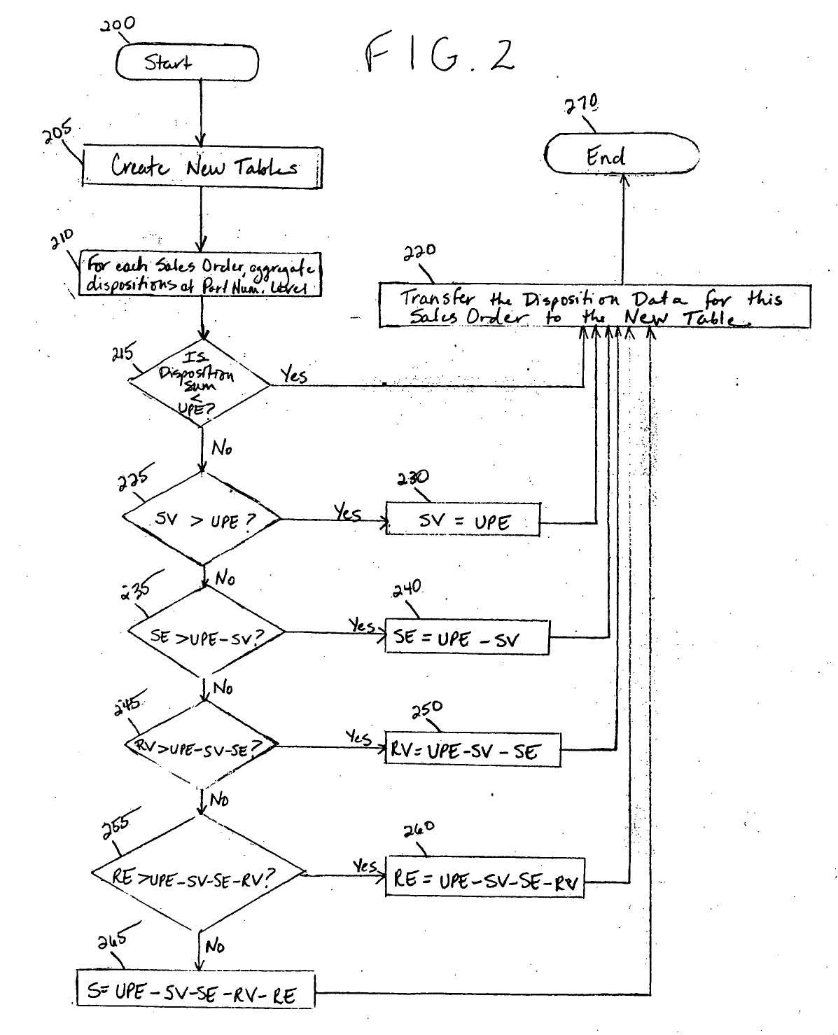

Block 125 then cleanses the merged data in a process that is illustrated in FIG. 2. Once the data has been cleansed, block 125 populates the templates with the data extracted from database 100 to create parts disposition profiles for each part family. More specifically, each extracted disposition record, which represents the historical disposition of a part, will be added to its' corresponding parts disposition template. Using the above template, if a record is processed in which part family 72-33-03 of engine family PW4000 (medium workscope) is repaired at the engine center, the corresponding fields of the template will be incremented by one. For example:

| | Work- | | | | | | | | |
|---|---|---|---|---|---|---|---|---|---|
| Eng. Fam. | scope | Part Fam. | SV | SE | RV | RE | S | Exp. | Total |
| PW4000 | Medium | 72-33-03 | | | | 1 | | 1 | 1 |

When all of the extracted records have been processed, a total number of dispositions will be determined for all of the disposition categories. The exposure percentage, described above, will also be calculated and stored in the parts disposition profile. The disposition profiles will be continually updated as new records are added to database 100. Once all of the data has been added to the profiles, a sample profile may appear as follows:

| Eng. Fam. | Workscope | Part Fam. | UPE | SV | SE | RV | RE | S | Exp. | Total | Exp. % |
|---|---|---|---|---|---|---|---|---|---|---|---|
| PW4000 | Medium | 72-33-03 | 12 | 0 | 3 | 0 | 28 | 0 | 13 | 19 | 68% |

Next, all of the disposition percentages can be created. For example, to calculate the percentage of parts that were repaired at the engine center, the total number of engines serviced (for a certain part family) is multiplied by the number of units per engine for that part family and then divided into the total number of parts that were repaired at the engine center. Using the above profile, the percentage of parts belonging to part family 72-33-03 of engine family PW4000 (medium workscope) that were repaired at the engine center is figured using the following equation:
% RE=Total num of parts repaired at engine center/(Total engines serviced*UPE)

Filling in the values will give us:
% RE=28/(19*12) or ˜12%

After the disposition percentages are calculated, short-term and long-term demand forecasts may be created. A short-term forecast may represent a period of a year or less and may be used to determine immediate and near future demand. A long-term forecast, however, may represent a period of more than a year and may be used for strategic purposes, such as capacity planning.

Databases 135 and 140, containing engine schedule data for internal and external customers are used by block 145 to create a long-term forecast. These data represent future shop visits scheduled by customers for repair or maintenance on their engines. Block 145 creates the long-term forecast by multiplying the disposition profiles by the number of engines that are booked for servicing or repair.

More specifically, and using 12 as the percentage of parts repaired at the engine center, if a customer is bringing in 10 engines to be overhauled, which fall under the grouping engine family PW4000 (medium workscope), the volume of parts belonging to part family 72-33-03 that will be seen by the company may be calculated in the following way:
Total Volume=Num. of Engines×Units per Engine×Exposure Rate×(RE)

Filling in the values will give us:
Total Volume=10×12×68%×(12%) or ˜10

This number represents the number of parts belonging to the above part family that the company should anticipate repairing. This forecast can help determine quantities such as labor staffing levels, skill mix, number of shifts required and assist with determining line balancing, equipment/capital requirements, and offload/outsourcing requirements. The forecast can also be altered to determine different scenarios based on demand changes, the phasing in and out of products, process changes, efficiency changes, and changes in available working time, e.g., shutdowns.

Vendor information at block 150 is used by block 155 to create a long-term forecast that will be allocated to the appropriate vendor. The vendor information that will be used includes the name of each vendor, along with the share of parts belonging to each part family that it provides to the company. If we then calculate a forecast including parts belonging to a particular part family that will scrapped or repaired at the vendor, we can multiply that value by a particular vendor's share of the corresponding part family to determine the vendor allocation for that part family.

Block 130 creates a short-term forecast using specific part numbers rather than part families. The short-term forecast is created in the same manner as the long-term forecast, except the profiles are created at the specific part number level rather than the part family level. Many different groups can utilize the long-term and the short-term forecasts, including the overhaul facility, repair facilities that repair parts sourced to the facility by the overhaul shop, vendors that supply spare parts and/or materials, and material and/or operation personnel and managers.

FIG. 2 illustrates the process of cleansing the data, which is utilized in the method of FIG. 1. This process ensures that, for each sales order (i.e., repairs done on a single engine) the total number of dispositions for a specific part does not exceed the total number of units per engine. The process begins at 200. Block 205 creates two new tables (e.g., Table2 and Table3), having fields identical to those extracted from database 100, but having additional fields for storing the total dispositions for each sales order. Block 210 aggregates all the dispositions for each sales order associated with a certain part, and stores the information in Table2. Take the following example, which contains disposition sums for sales order 000123 associated with part 53D925:

| Order # | Cust. # | Eng. Ser. # | Workscope | Part # | UPE | SV | SE | RV | RE | S |
|---|---|---|---|---|---|---|---|---|---|---|
| 000123 | Cust1 | 4567A | Medium | 53D925 | 12 | 2 | 3 | 1 | 3 | 6 |

Block 215 takes the sum of all of the dispositions (15) and determines whether or not it is less than the number of units per engine for part 53D925 (12). If it is, control passes to block 220, where the disposition data for this part is transferred to Table3.

If it is not, as in the case of our example, control passes to block 225. Block 225 determines whether the number of parts “scrapped at vendor” (2) is greater than the number of units per engine (12). If it is, control passes to block 230, where the number of parts “scrapped at vendor” is reset to the number of units per engine. Control further passes to block 220, where the disposition data for this part is transferred to Table3.

If it is not greater, control passes to block 235. Block 235 determines whether the number of parts “scrapped at engine center” (3) is greater than the number of units per engine minus the number of parts “scrapped at vendor” (12−2=10). If it is, control passes to block 240, where the number of parts “scrapped at engine center” is reset to the number of units per engine minus the number of parts “scrapped at vendor.” Control further passes to block 220, where the disposition data for this part is transferred to Table3.

If it is not greater, as in the case of our example, control passes to block 245. Block 245 determines whether the number of parts “repaired at vendor” (1) is greater than the number of units per engine minus the number of parts “scrapped at vendor” minus the number of parts “scrapped at engine center” (12−2−3=5). If it is, control passes to block 250, where the number of parts “repaired at vendor” is reset to the number of units per engine minus the number of parts “scrapped at vendor” minus the number of parts “scrapped at engine center.” Control further passes to block 220, where the disposition data for this part is transferred to Table3.

If it is not greater, as in the case of our example, control passes to block 255. Block 255 determines whether the number of parts “repaired at engine center” (3) is greater than the number of units per engine minus the number of parts “scrapped at vendor” minus the number of parts “scrapped at engine center” minus the number of parts repaired at vendor” (12−2−3−1=6). If it is, control passes to block 260, where the number of parts “repaired at engine center” is reset to the number of units per engine minus the number of parts “scrapped at vendor” minus the number of parts “scrapped at engine center” minus the number of parts “repaired at vendor.” Control further passes to block 220, where the disposition data for this part is transferred to Table3.

If it is not greater, control passes to block 265. Block 265 then resets the number of parts “deemed serviceable” to the number of units per engine minus the number of parts “scrapped at vendor” minus the number of parts “scrapped at engine center” minus the number of parts “repaired at vendor” minus the number of parts “repaired at engine center” (12−2−3−1−3=3). Control further passes to block 220, where the disposition data for this part is transferred to Table3.

Once block 220 has transferred the disposition data, this iteration is finished at 270 and the next part record associated with a particular sales order is processed. This process continues until all of the records from Table1 have been cleansed and transferred to Table3. This process prioritizes the dispositions and prevents there from being instances where the total number of dispositions for a part number associated with a sales order is greater than the number of units per engine for that part. More specifically, if Cust1 brought in an engine to be serviced, all of the work done on that engine would refer to the same sales order number. In addition, for each disposition of any part that is worked on during this servicing, a record will be created. If there are 12 parts number 53D925 on this engine, there should not be more than 12 disposition records.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A method of forecasting demand, comprising the steps of:
providing a database containing information regarding a plurality of parts;
accessing the database to create a first demand forecast for at least one of the plurality of parts;
identifying a group from the plurality of parts; and
accessing the database to create a second demand forecast for the group.

2. The method of claim 1, wherein the first demand forecast is a short-term demand forecast.

3. The method of claim 1, wherein the second demand forecast is a long-term demand forecast.

4. The method of claim 1, further comprising the step of:
cleansing the information contained in the database.

5. The method of claim 4, wherein the step of cleansing comprises eliminating excess records.

6. The method of claim 1, further comprising the step of:
utilizing future shop visit data.

7. The method of claim 1, wherein the step of identifying a group from a plurality of parts includes the step of creating a profile for the group.

8. The method of claim 1, wherein the group represents customers.

9. The method of claim 1, wherein the group represents parts having similar workscopes.

10. The method of claim 1, wherein the group represents parts having functional similarities.

11. The method of claim 10, wherein the group is a part family.

12. The method of claim 1, further comprising the step of:
allowing human intervention.

13. The method of claim 1, wherein the forecasts are accessed via the Internet.

14. The method of claim 1, wherein the forecasts are spare parts forecasts.

15. The method of claim 1, wherein the forecasts are forecasts for the repair of the parts.

16. The method of claim 1, further comprising the step of:
providing at least one of the forecasts to at least one vendor.

17. The method of claim 1, wherein the parts are aerospace parts.

18. The method of claim 17, wherein the aerospace parts are gas turbine engine parts.

19. The method of claim 1, wherein the database contains historical information of services performed on the parts and scheduled information of services to be performed on the parts.

20. A computer assisted system for forecasting demand, the system comprising:
means for providing a database containing information regarding a plurality of parts;
means for accessing the database to create a first demand forecast for at least one of the plurality of parts;
means for identifying a group from the plurality of parts having similar characteristics; and
means for accessing the database to create a second demand forecast for the group.

21. The computer assisted system of claim 20, further comprising means for cleansing the information contained in the database.

22. The computer assisted system of claim 20, further comprising means for utilizing future shop visit data.

23. The computer assisted system of claim 20, further comprising means for allowing human intervention.

24. The computer assisted system of claim 20, further comprising means for providing at least one of the forecasts to at least one vendor.

25. A method of forecasting demand, comprising the steps of:
providing a database containing information regarding a plurality of parts, at least two of the parts having a common attribute;
accessing the database to create a first demand forecast for at least one of the plurality of parts;
accessing the database to create a second demand forecast for the parts having the common attribute.

26. A method of forecasting demand, comprising the steps of:
providing a database containing information regarding a plurality of parts;
accessing the database to create a first demand forecast at a part number level; and
accessing the database to create a second demand forecast at a part family level.

27. The method of claim 26, wherein the parts comprise aerospace parts.

28. The method of claim 27, wherein the parts comprise gas turbine engine parts.

29. The method of claim 26, wherein the database contains historical information of services performed on gas turbine engines and scheduled information of services to be performed on gas turbine engines.
